(19) United States
(12) Patent Application Publication
(10) Pub. No.: US 2022/0281030 A1
(43) Pub. Date: Sep. 8, 2022

(54) JOINING APPARATUS

(71) Applicant: HONDA MOTOR CO., LTD., Tokyo (JP)

(72) Inventors: Akihiko TAKAHASHI, Saitama (JP); Yasuhiro KAWAI, Saitama (JP); Makoto TANAKA, Saitama (JP); Kenta KAWARAI, Saitama (JP)

(21) Appl. No.: 17/676,832

(22) Filed: Feb. 22, 2022

(30) Foreign Application Priority Data
Mar. 5, 2021 (JP) 2021-035149

(51) Int. Cl. B23K 26/26; B23K 26/08; B23K 37/04

(52) U.S. Cl. CPC B23K 26/26; B23K 26/083; B23K 37/0408; B23K 2101/18

(57) ABSTRACT

A joining apparatus includes a pressor that cause the first joint target portion and the second joint target portion to butt against each other, a workpiece moving organizer that moves the first workpiece and the second workpiece along an extending direction of the first joint target portion and the second target portion, a separator that temporarily separates the first joint target portion and the second joint target portion from each other by deforming a part of a butting site between the first joint target portion and the second joint target portion; and a laser irradiator that irradiates a site at which the first joint target portion and the second joint target portion separated from each other approach each other again, with laser light on a downstream side of the separator in a moving direction of the first workpiece and the second workpiece.

This application is based on and claims the benefit of priority from Japanese Patent Application No. 2021-35149, filed on 5 Mar. 2021, the content of which is incorporated herein by reference.

### BACKGROUND OF THE INVENTION

### Field of the Invention

The present invention relates to a joining apparatus.

### Related Art

There has been conventionally known a joining apparatus in which joint target portions of two workpieces are caused to butt against each other and a butting site at which the joint target portions butt against each other is irradiated with laser light to weld the two workpieces (for example, see Patent Document 1).
Patent Document 1: Japanese Patent No. 6242109

### SUMMARY OF THE INVENTION

The joint target portions of the two workpieces which are caused to butt against each other are respectively melted and joined to each other by irradiating them with laser light from above. However, when the butting site is irradiated with laser light from above, there is a problem that the way of heat transfer is different between the upper surface of a workpiece that is irradiated with laser light and the lower surface of the workpiece that is not irradiated with laser light, so that it is impossible to efficiently heat the entire butting site containing end faces of the joint target portions. If the entire butting site is not heated efficiently, for example, when the workpiece has a galvanized (zinc-plated) layer on the surface thereof, it would be impossible to sufficiently remove the galvanized layer on the end face of the joint target portion, so that the joint quality may deteriorate.

Therefore, an object of the present invention is to provide a joining apparatus capable of efficiently heating and joining joint target portions of two workpieces.

(1) A joining apparatus (for example, a joining apparatus 1 described later) for joining a first workpiece (for example, a workpiece W1 described later) having a first joint target portion (for example, a first joint target portion W11 described later) extending linearly and a second workpiece (for example, a workpiece W2 described later) having a second joint target portion (for example, a second joint target portion W21 described later) extending linearly, comprises: a pressor (for example, a first upstream side roller 31a, a first downstream side roller 31b, a side pressing mechanism 312 described later) that presses at least one of the first workpiece and the second workpiece to the other workpiece to cause the first joint target portion and the second joint target portion to butt against each other; a workpiece moving organizer (for example, conveying rollers 15,16, and guide roller 17 described later) that moves the first workpiece and the second workpiece along an extending direction (for example, a D direction described later) of the first joint target portion and the second target portion in a state where the first joint target portion and the second joint target portion are caused to butt against each other; a separator (for example, a separating member 4, an elevating actuator 41 described later) that temporarily separates the first joint target portion and the second joint target portion from each other by deforming a part of a butting site (for example, a butting site Wa described later) between the first joint target portion and the second joint target portion so that the part of the butting site is turned up during a moving process of the first workpiece and the second workpiece; and a laser irradiator (for example, a laser irradiation unit 2 described later) that irradiates a site (for example, a re-approaching site Wa1 described later) at which the first joint target portion and the second joint target portion separated from each other approach each other again, with laser light on a downstream side of the separator in a moving direction of the first workpiece and the second workpiece.

(2) In the joining apparatus described in the foregoing (1), the pressor comprises a first pressor (for example, the first upstream side roller 31a, the first downstream side roller 31b, the side pressing mechanism 312 described later) that presses at least one of the first workpiece and the second workpiece to the other before the laser light is radiated by the laser irradiator, and a second pressor (for example, a first upper surface pinching roller 51a, a first lower surface pinching roller 51b, an upper surface width direction pressing mechanism 511, a lower surface width direction pressing mechanism 514 described later) that presses at least one of the first workpiece and the second workpiece to the other at a position where the site is irradiated with the laser light by the laser irradiator, and the second pressor has a larger pressing force (for example, a pressing force F2 described later) than that (for example, a pressing force F1 described later) of the first pressor.

(3) In the joining apparatus described in the foregoing (1) or (2), the pressor includes a restrainer (for example, a first upper surface holding roller 61a, a first lower surface holding roller 61b, a second upper surface holding roller 62a, a second lower surface holding roller 62b described later) that restrains a deformation range of the butting site when the butting site is turned up by the separator.

According to the foregoing (1), the site at which the first joint target portion and the second joint target portion which have been deformed to be turned up by the separator approach each other again can be irradiated with laser light, so that the site just before the first joint target portion and the second joint target portion approach each other again can be melted directly with laser light. Therefore, the respective target portions containing the end faces of the first and second joint target portions can be efficiently heated and joined with a small amount of heat, so that excessive heating is suppressed and the joint quality can be improved. Further, since efficient heating can be performed, it is expected that the processing speed is improved and the capital investment of the laser oscillator is reduced.

According to the foregoing (2), the pressing force to be applied to the workpiece for causing the first joint portion and the second joint portion to butt against each other is set to be larger at a position irradiated by laser light than that before the position irradiated by laser light, whereby the first joint portion and the second joint portion which have been melted by the laser light can be brought into excellent contact with each other. Therefore, the joint quality of the workpieces can be further enhanced.

According to the foregoing (3), since vibration caused by the movement of each joint target portion and excessive deformation of the butting site turned up by the separator are suppressed, the workpieces can be easily positioned when the separated first and second joint target portions approach each other again. Therefore, the joint quality can be further enhanced.

### BRIEF DESCRIPTION OF THE DRAWINGS

FIG. 1 is a perspective view showing a joining apparatus according to one embodiment of the present invention;

FIG. 2 is a perspective view showing a main part of the joining apparatus according to one embodiment of the present invention;

FIG. 3 is a plan view showing a main part of the joining apparatus according to one embodiment of the present invention;

FIG. 4 is a cross-sectional view showing a main part of the joining apparatus according to one embodiment of the present invention;

FIG. 5 is a diagram of workpieces separated from each other at a butting site when viewed from the upstream side in a moving direction of the workpieces;

FIG. 6 is a side view showing a main part of the joining apparatus according to one embodiment of the present invention;

FIG. 7 is a perspective view of a laser light irradiation site in the joining apparatus according to one embodiment of the present invention when the irradiation site is viewed from the downstream side in the moving direction of the workpieces; and FIG. 8 is a diagram showing an irradiation region of laser light to the joint target portions of the workpieces which are separated from each other.

### DETAILED DESCRIPTION OF THE INVENTION

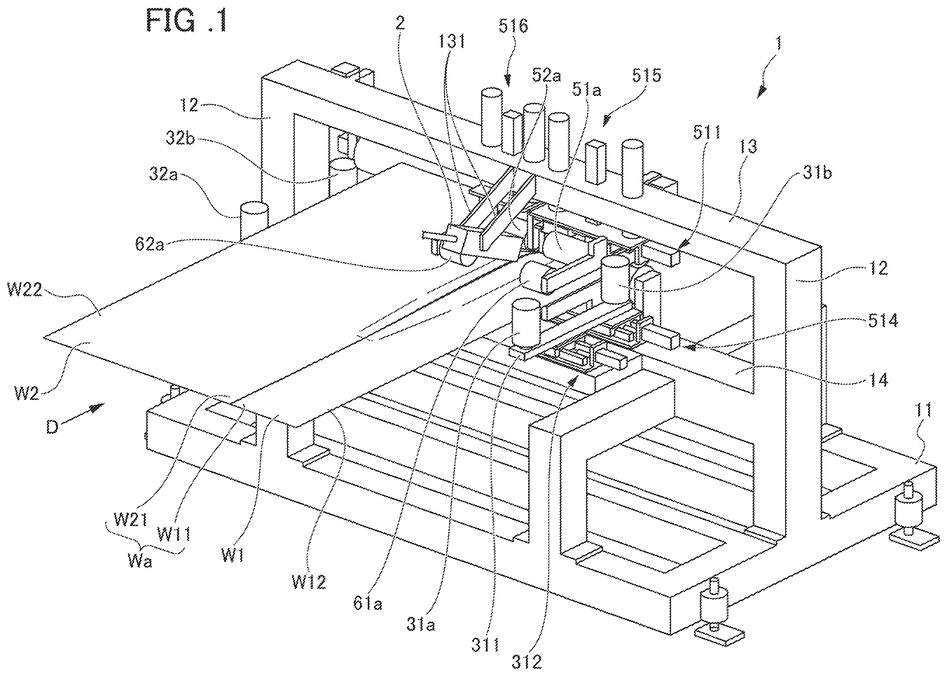

An embodiment of the present invention will be described in the following in detail with reference to the drawings. As shown in FIGS. 1 to 4, a joining apparatus 1 joins two workpieces W1 and W2 each made of a metal plate by irradiation them with laser light. In the present embodiment, the workpieces W1 and W2 are constituted of galvanized steel sheets whose surfaces have been galvanized, and have a joint target portion W11 and a joint target portion W21 which are respectively provided on the side end portions thereof and linearly extend along a D direction.

In the present embodiment, the workpiece W1 is a first workpiece and the work piece W2 is a second workpiece. The joint target portion W11 is a first joint target portion, and the joint target portion W21 is a second joint target portion.

The joining apparatus 1 radiates laser light from a laser irradiation unit 2 to a butting site Wa at which the joint target portions W11 and W21 of the workpieces W1 and W2 are caused to butt against each other while moving the workpieces W1 and W2 along the D direction which is an extending direction of the joint target portions W11 and W12 in a state where the joint target portions W11 and W21 are caused to butt against each other, thereby joining the workpieces W1 and W2. In the present specification, the terms of “upstream side” and “downstream side” are defined as indicating an upstream side and a downstream side along the moving direction of the workpieces W1 and W2 which are along the D direction.

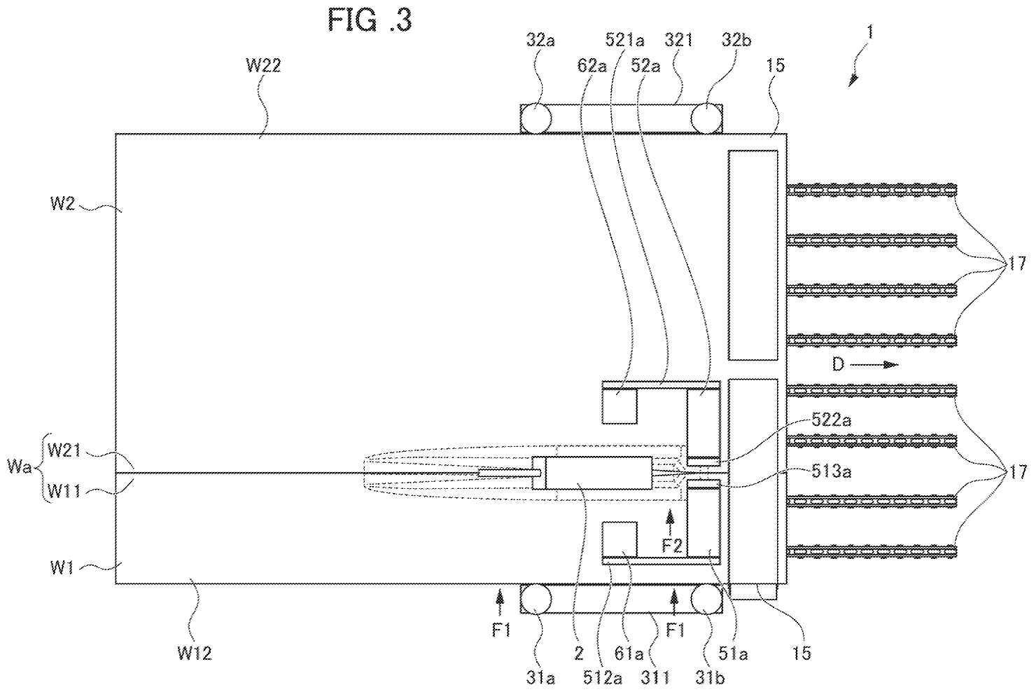

The joining apparatus 1 includes a base frame 11 installed on the floor surface, a pair of vertical frames 12 rising upward from both ends of the base frame 11 along the width direction of the joining apparatus 1 which is orthogonal to the D direction, and an upper horizontal frame 13 and a lower horizontal frame 14 which are bridged along the width direction of the joining apparatus 1 over the pair of vertical frames 12 and arranged so as to be vertically spaced from each other. Pairs each including a conveying roller 15 and a conveying roller 16, which are arranged on the downstream side of the upper horizontal frame 13 and the lower horizontal frame 14, pinch the workpieces W1 and W2 from above and below. In FIG. 3, the frame of the joining apparatus 1 is not illustrated.

The configuration of each part of the joining apparatus 1 will be described in the following.

### (Conveying Roller and Guide Roller)

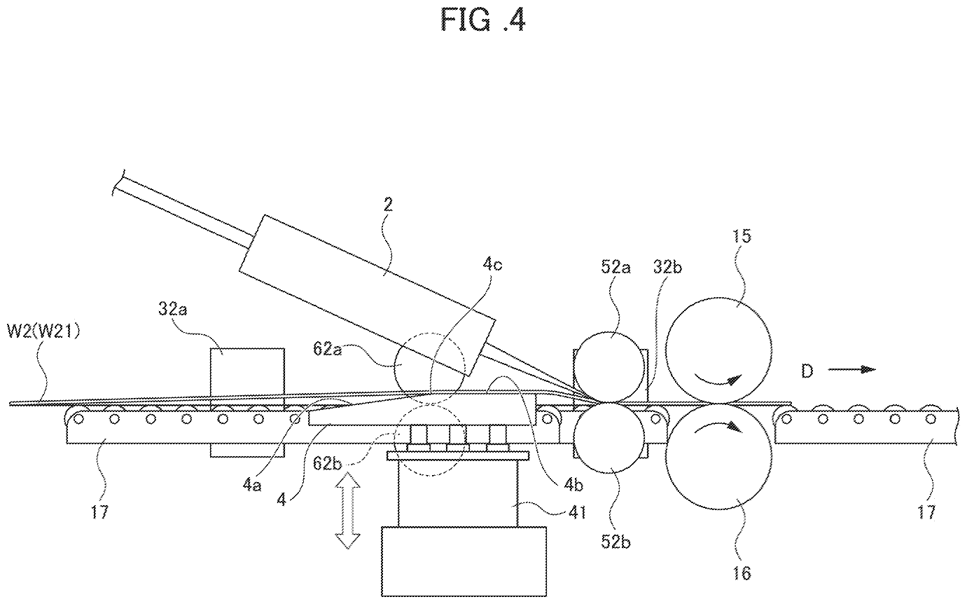

As shown in FIGS. 3 and 4, the rotation axes of the conveying rollers 15 and 16 are arranged along the width direction of the joining apparatus 1, respectively. The conveying rollers 15 and 16 are rotated by driving a motor (not shown) to move the workpieces W1 and W2 at a predetermined speed along the D direction which is the extending direction of the joint target portions W11 and W21 in a state where the joint target portions W11 and W21 are caused to butt against each other.

In the present embodiment, respective pairs of conveying rollers 15 and 16 are arranged along the width direction of the joining apparatus 1. The paired conveying rollers 15 and 16 of one of the respective pairs are arranged so as to cover and pinch the butting site Wa from above and below. If the plate thicknesses of the workpieces W1 and W2 are different from each other and thus the butting site Wa is stepped when the workpieces W1 and W2 are joined to each other, the butting site Wa may be arranged between the respective pairs of conveying rollers 15 and 16 so that the butting site Wa is not pinched from above and below by the conveying rollers 15 and 16.

A plurality of guide rollers 17 extending along the moving direction of the workpieces W1 and W2 are provided on the upstream side and the downstream side of the upper horizontal frame 13 and the lower horizontal frame 14 with the conveying rollers 15 and 16 being sandwiched therebetween. The plurality of guide rollers 17 are arranged in parallel in the width direction of the joining apparatus 1. The guide rollers 17 support the lower surfaces of the workpieces W1 and W2 moved by the conveying rollers 15 and 16, and form a movement path of the workpieces W1 and W2 passing between the upper horizontal frame 13 and the lower horizontal frame 14.

In the present embodiment, the conveying rollers 15,16 and the guide rollers 17 constitutes a workpiece moving mechanism (i.e., organizer) that moves the workpieces W1 and W2 along the extending direction of the joint target portions W11 and W21 in a state where the joint target portions W1l and W21 are caused to butt against each other.

### (Laser Irradiation Unit)

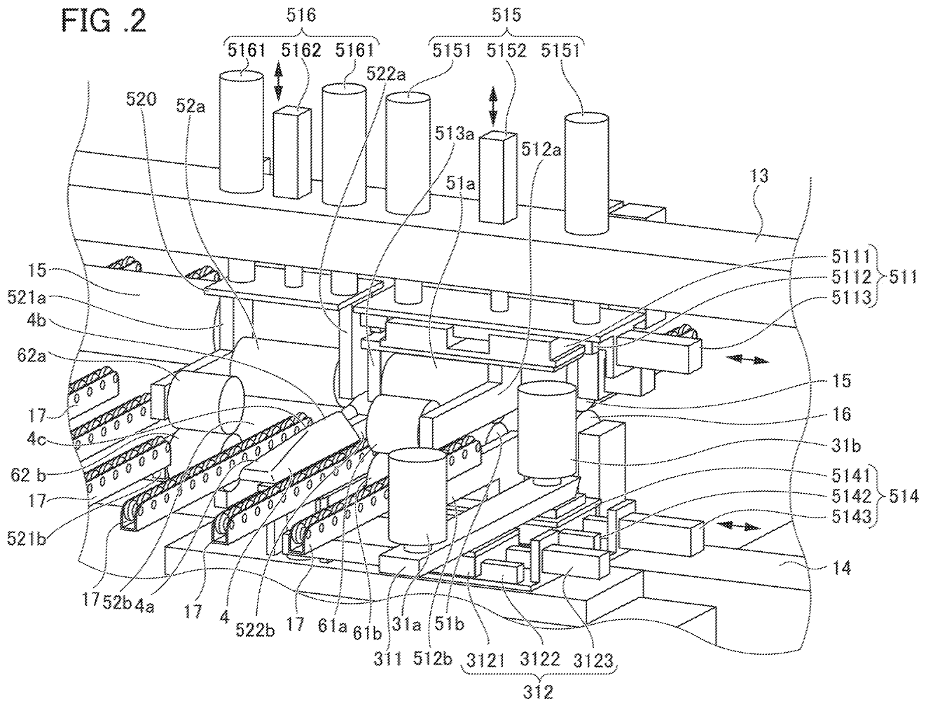

The laser irradiation unit 2 is installed on the upstream side of the upper horizontal frame 13 via a mounting unit 131, and arranged just above the butting site Wa of the workpieces W1 and W2 that move through the gap between the upper horizontal frame 13 and the lower horizontal frame 14. The laser irradiation unit 2 irradiates the butting site Wa of the workpieces W1 and W2 with laser light from above by driving a laser driving unit (not shown). As shown in FIG. 4, the laser irradiation unit 2 of the present embodiment is arranged so as to irradiate the butting site Wa with laser light diagonally downward from the upstream side to the downstream side, but the laser irradiation unit 2 is not limited to such a configuration as long as it is possible to irradiate the butting site Wa with laser light from a direction which is separated from the butting site Wa. In FIGS. 2 and 3, the illustration of the laser irradiation unit 2 is omitted.

In the present embodiment, the laser irradiation unit 2 constitutes a laser light irradiator together with the laser driving unit.

### (Side Roller)

The lower horizontal frame 14 of the joining apparatus 1 has side rollers which are provided so as to sandwich the workpieces W1 and W2 moving on the guide rollers 17 from the width direction. The side roller of the present embodiment is constituted by a pair of a first upstream side roller 31a and a first downstream side roller 31b, and a pair of a second upstream side roller 32a and a second downstream side roller 32b. The rotation axes of the first upstream side roller 31a and the first downstream side roller 31b, and the rotation axes of the second upstream side roller 32a and the second downstream side roller 32b are arranged along the vertical direction, respectively. The pair of the first upstream side roller 31a and the first downstream side roller 31b and the pair of the second upstream side roller 32a and the second downstream side roller 32b are arranged symmetrically with each other with the workpieces W1 and W2 being sandwiched therebetween.

As shown in FIGS. 1, 3 and 6, the paired first upstream and downstream side rollers 31a and 31b are rotatably provided on a roller support plate 311 extending along the moving direction of the workpiece W1 so as to be spaced from each other at a predetermined interval along the moving direction of the workpiece W1. With respect to the workpiece W1 introduced into the joining apparatus 1, the first upstream side roller 31a and the first downstream side roller 31b are in contact with an outer side end portion W12 of the workpiece W1 which is arranged on the opposite side to the joint target portion W11. As a result, the paired first upstream side roller 31a and first downstream side roller 31b rotate in conjunction with the movement of the workpiece W1 to support the smooth movement of the workpiece W1.

The second upstream side roller 32a and the second downstream side roller 32b are rotatably provided on a roller mounting plate 321 extending along the moving direction of the workpiece W2 so as to be spaced from each other at a predetermined interval along the moving direction of the workpiece W2. With respect to the workpiece W2 introduced into the joining apparatus 1, the second upstream side roller 32a and the second downstream side roller 32b are in contact with an outer side end portion W22 of the workpiece W2 which is arranged on the opposite side to the joint target portion W21. As a result, the paired second upstream side roller 32a and second downstream side roller 32b rotate in conjunction with the movement of the workpiece W2 to support the smooth movement of the workpiece W2.

As shown in FIGS. 1, 2 and 6, the roller support plate 311 for supporting the first upstream side roller 31a and the first downstream side roller 31b is attached to a side pressing mechanism 312 provided on the lower horizontal frame 14. The side pressing mechanism 312 includes a slide portion 3121 fixed to the roller support plate 311, a guide rail 3122 which extends in the width direction of the joining apparatus 1 and guides the movement of the slide portion 3121, and an actuator 3123 connected to the slide portion 3121. The actuator 3123 drives the slide portion 3121 and the roller support plate 311 so that the slide portion 3121 and the roller support plate 311 are moved inwardly (toward the workpiece W1) in the width direction of the joining apparatus 1 along the guide rail 3122. Therefore, the first upstream side roller 31a and the first downstream side roller 31b are provided so as to be movable inwardly in the width direction of the joining apparatus 1 by driving the actuator 3123 of the side pressing mechanism 312.

On the other hand, the roller mounting plate 321 for supporting the second upstream side roller 32a and the second downstream side roller 32b is fixed so as to be immovable to the lower horizontal frame 14. Therefore, the second upstream side roller 32a and the second downstream side roller 32b define the position of the side end portion W22 of the workpiece W2 by supporting the movement of the side end portion W22 of the workpiece W2.

When the first upstream side roller 31a and the first downstream side roller 31b move inwardly in the width direction of the joining apparatus 1 by driving the actuator 3123, the first upstream side roller 31a and the first downstream side roller 31b press the workpiece W1 conveyed by the conveying rollers 15 and 16 toward the workpiece W2. At this time, the second upstream side roller 32a and the second downstream side roller 32b function as a receiving portion which comes into contact with the side end portion W22 of the workpiece W2 to restrict excessive movement of the workpieces W1 and W2 toward the second upstream side roller 32a and the second downstream side roller 32b. Therefore, the joint target portions W11 and W21 of the workpieces W1 and W2 which are introduced into the joining apparatus 1 in a state where the joint target portions W11 and W21 are caused to butt against each other are pressed against each other in such a direction as to come into closer contact with each other by the workpieces W1 and W2 passing between the first upstream side roller 31a and the second upstream side roller 32a and between the first downstream side roller 31b and the second downstream side roller 32b.

In the present embodiment, the first upstream side roller 31a, the first downstream side roller 331b and the side pressing mechanism 312 constitutes a first pressor that presses at least one (workpiece W1) of the workpieces W1 and W2 toward the other (workpiece W2) before the workpieces W1 and W2 are irradiated with laser light from the laser irradiation unit 2 out of pressors for pressing at least one (workpiece W1) of the workpieces W1 and W2 to the other (workpiece W2) to cause the joint target portions W11 and W21 to butt against each other.

### (Separating Member)

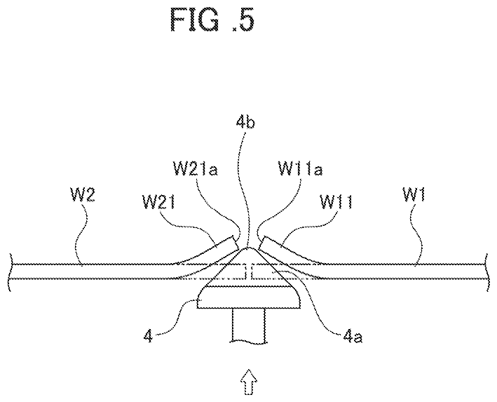

As shown in FIGS. 2 and 4, a separating member 4 is arranged below the butting site Wa of the workpieces W1 and W2. The separating member 4 is constituted by a metal block body elongated along the moving direction of the workpieces W1 and W2, and is provided so as to be vertically movable by driving an elevating actuator 41 arranged below the guide rollers 17. The upper surface of the separating member 4 has a flat surface portion 4a which inclines downward to the upstream side, and a ridgeline 4b which is continuous with the downstream side of the flat surface portion 4a and consists of a top portion protruding in a triangular shape as shown in FIGS. 2 and 5. The ridgeline 4b extends along the moving direction of the workpieces W1 and W2, that is, the extending direction of the butting site Wa.

The separating member 4 is arranged just below the butting site Wa and between the first and second upstream side rollers 31a and 32a arranged on the upstream side and the first and second downstream side rollers 31b and 32b arranged on the downstream side so that the ridgeline 4b is along the extending direction of the butting site Wa. When the separating member 4 is moved upward by driving the elevating actuator 41, as shown in FIG. 5, the separating member 4 deforms a part of the butting site Wa so that the part of the butting site Wa is turned up from the lower side to the upper side, thereby temporarily separating the joint target portions W11 and W21 from each other.

In the present embodiment, the separating member 4 and the elevating actuator 41 constitute a separator that temporarily separates the joint target portions W11 and W21 from each other by deforming a part of the butting site Wa so that the part of the butting site Wa is turned up in the step of moving the workpieces W1 and W2.

### (Pinching Roller)

A pinching roller is provided on the upstream side of the conveying rollers 15 and 16 of the joining apparatus 1 and on the downstream side of the separating member 4 so as to pinch the workpieces W1 and W2 moving on the guide rollers 17 from above and below. The pinching roller of the present embodiment is constituted by a pair of a first upper surface pinching roller 51a and a first lower surface pinching roller 51b, and a pair of a second upper surface pinching roller 52a and a second lower surface pinching roller 52b. The rotation axes of the first upper surface pinching roller 51a and the first lower surface pinching roller 51b, and the rotation axes of the second upper surface pinching roller 52a and the second lower surface pinching roller 52b are arranged along the width direction of the joining apparatus 1, respectively.

The first upper surface pinching roller 51a and the first lower surface pinching roller 51b are arranged on the workpiece W1 side with respect to the butting site Wa. The second upper surface pinching roller 52a and the second lower surface pinching roller 52b are arranged on the workpiece W2 side with respect to the butting site Wa. The pair of first upper surface pinching roller 51a and first lower surface pinching roller 51b and the pair of second upper pinching roller 52a and second lower surface pinching roller 52b are arranged on both sides of the butting site Wa in proximity to the butting site Wa so that the butting site Wa is arranged between the pairs. The pair of first upper surface pinching roller Sla and first lower surface pinching roller 51b and the pair of second upper surface pinching roller 52a and second lower surface pinching roller 52b are arranged symmetrically with each other with the butting site Wa being sandwiched therebetween. The laser light to be emitted from the laser irradiation unit 2 is applied to the butting site Wa between the pair of first upper surface pinching roller 51a and first lower surface pinching roller 51b and the pair of second upper surface pinching roller 52a and the second lower surface pinching roller 52b.

### (1) First Upper Surface Pinching Roller Sla, First Lower Surface Pinching Roller 51b

First, the paired first upper surface pinching roller Sla and first lower surface pinching roller 51b that pinch the workpiece W1 therebetween will be described. The paired first upper surface pinching roller 51a and first lower surface pinching roller 51b are provided so as to be movable in the rotation axis direction with respect to the upper horizontal frame 13 and the lower horizontal frame 14, respectively.

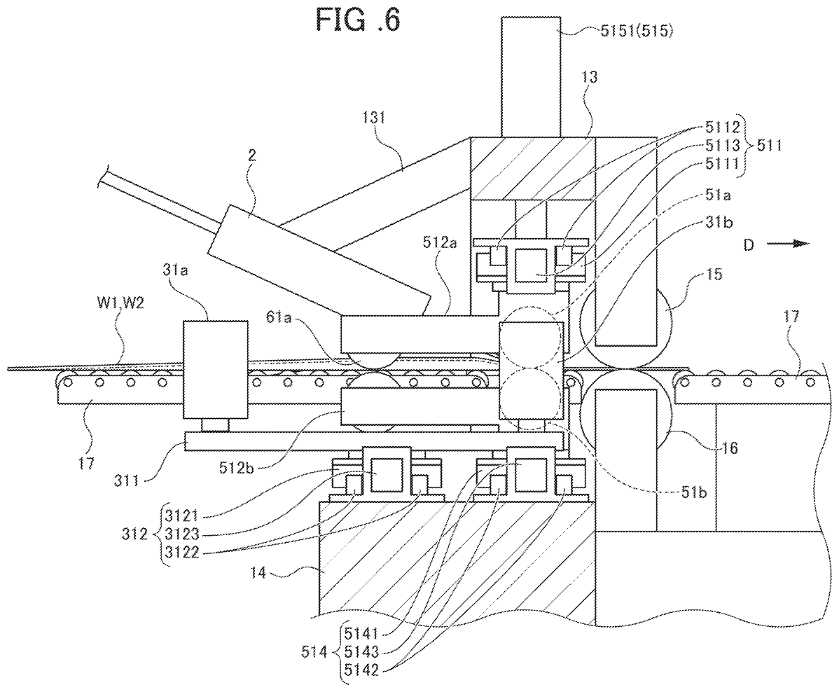

Specifically, the first upper surface pinching roller 51a is provided on an upper surface width direction pressing mechanism 511 attached to the upper horizontal frame 13. As shown in FIGS. 2 and 6, the upper surface width direction pressing mechanism 511 includes a slide portion 5111, a guide rail 5112 which extends in the width direction of the joining apparatus 1 and guides the movement of the slide portion 5111, and an actuator 5113 connected to the slide portion 5111. The first upper surface pinching roller 51a is rotatably attached between roller support frames 512a and 513a which protrude downward from the slide portion 5111.

The roller support frame 512a which is arranged on a farther side from the butting site Wa of the workpieces W1 and W2 out of the roller support frames 512a and 513a is formed in an L-shape extending from the mounting site of the first upper surface pinching roller 51a to the upstream side, and a first upper surface holding roller 61a described later is rotatably attached on the upstream end of the L-shaped roller support frame 512a.

The actuator 5113 of the upper surface width direction pressing mechanism 511 drives the slide portion 5111 so that the slide portion 5111 moves inwardly in the width direction of the joining apparatus 1 along the guide rail 5112. Therefore, the first upper surface pinching roller Sla supported by the slide portion 5111 via the roller support frames 512a and 513a is provided to be movable inwardly in the width direction of the joining apparatus 1, that is, in the rotation axis direction toward the butting site Wa by driving the actuator 5113 of the upper width direction pressing mechanism 511.

The first lower surface pinching roller Sib is provided on a lower surface width direction pressing mechanism 514 attached on the lower horizontal frame 14. As shown in FIGS. 2 and 6, the lower surface width direction pressing mechanism 514 includes a slide portion 5141, a guide rail 5142 which extends in the width direction of the joining apparatus 1 and guides the movement of the slide portion 5141, and an actuator 5143 connected to the slide portion 5141. The first lower surface pinching roller 51b is rotatably attached between roller support frames 512b and 513b protruding upward from the slide portion 5141.

The roller support frame 512b which is arranged on a farther side from the butting site Wa of the workpieces W1 and W2 out of the roller support frames 512b and 513b is formed in an L-shape extending from a mounting site of the first lower surface pinching roller 51b to the upstream side, and a first lower surface holding roller 61b described later is rotatably attached to an upstream end of the L-shaped roller support frame 512b.

The actuator 5143 of the lower surface width direction pressing mechanism 514 drives the slide portion 5141 so that the slide portion 5141 moves inwardly in the width direction of the joining apparatus 1 along the guide rail 5142. Therefore, the first lower surface pinching roller 51b supported by the slide portion 5141 via the roller support frames 512b and 513b is provided to be movable inwardly in the width direction of the joining apparatus 1, that is, in the rotation axis direction to the butting site Wa by driving the actuator 5143 of the lower surface width direction pressing mechanism 514. In FIGS. 2 and 6, the roller support frame 513b which is arranged inwardly in the width direction of the joining apparatus 1 out of the roller support frames 512b and 513b is hidden and thus is not visible.

The upper surface width direction pressing mechanism 511 is connected to the first downward pressing mechanism 515 provided on the upper horizontal frame 13. The first downward pressing mechanism 515 includes a plurality of cylinders 5151 vertically penetrating the upper horizontal frame 13, and one actuator 5152. The plurality of cylinders 5151 support the entire upper surface width direction pressing mechanism 511 just below the upper horizontal frame 13 so as to be vertically movable. The actuator 5152 drives the entire upper surface width direction pressing mechanism 511 so that the upper surface width direction pressing mechanism 511 moves downward toward the lower workpiece W1.

On the other hand, the lower surface width direction pressing mechanism 514 is provided so as to be vertically immovable with respect to the lower horizontal frame 14. Therefore, when the actuator 5152 of the first downward pressing mechanism 515 is driven, the upper surface width direction pressing mechanism 511 moves downward, so that the first upper surface pinching roller 51a attached to the slide portion 5111 presses the workpiece W1 downward to pinch the workpiece W1 with the first lower surface pinching roller 51b with a predetermined pinching force. A downward pressing force may be applied to the first upper surface pinching roller 51a by a plurality of cylinders 5151 instead of the actuator 5152.

### (2) Second Upper Surface Pinching Roller 52a, Second Lower Surface Pinching Roller 52b

Next, the paired second upper surface pinching roller 52a and second lower surface pinching roller 52b which pinch the workpiece W2 will be described. The paired second upper surface pinching roller 52a and second lower surface pinching roller 52b that pinch the workpiece W2 are different from the paired first upper surface pinching roller 51a and first lower surface pinching roller 51b, and both the rollers 52a and 52b are provided so as to be immovable in the rotation axis direction.

Specifically, as shown in FIG. 2, the second upper surface pinching roller 52a is rotatably attached between the roller support frames 521a and 522a protruding downward from a mounting board 520 arranged just below the upper horizontal frame 13.

The roller support frame 521a which is arranged on a farther side from the butting site Wa of the workpieces W1 and W2 out of the roller support frames 521a and 522a is formed in an L-shape extending from a mounting site of the second upper surface pinching roller 52a to the upstream side, and a second upper surface holding roller 62a described later is rotatably attached to an upstream end of the L-shaped roller support frame 521a.

The second lower surface pinching roller 52b is rotatably attached between the roller support frames 521b and 522b protruding upward from the lower horizontal frame 14.

The roller support frame 521b which is arranged on a farther side from the butting site Wa of the workpieces W1 and W2 out of the roller support frames 521b and 522b is formed in an L-shape extending from a mounting site of the second lower surface pinching roller 52b to the upstream side, and a second lower surface holding roller 62b described later is rotatably attached to an upstream end of the L-shaped roller support frame 521b.

The mounting board 520 that rotatably supports the second upper surface pinching roller 52a is connected to the second downward pressing mechanism 516 provided on the upper horizontal frame 13. The second downward pressing mechanism 516 includes a plurality of cylinders 5161 that vertically penetrate the upper horizontal frame 13, and one actuator 5162. The plurality of cylinders 5161 support the mounting board 520 just below the upper horizontal frame 13 so as to be vertically movable. The actuator 5162 drives the mounting board 520 so that the mounting board 520 is moved downward toward the lower workpiece W2.

On the other hand, the second lower surface pinching roller 52b is provided so as to be vertically immovable with respect to the lower horizontal frame 14. Therefore, when the actuator 5162 of the second downward pressing mechanism 516 is driven, the mounting board 520 moves downward, so that the second upper surface pinching roller 52a attached on the mounting board 520 presses the work piece W2 downward, and pinches the workpiece W2 with the second lower surface pinching roller 52b with a predetermined pinching force. A downward pressing force may be applied to the second upper surface pinching roller 52a by a plurality of cylinders 5161 instead of the actuator 5162.

The actuator 5113 of the upper surface width direction pressing mechanism 511 and the actuator 5143 of the lower surface width direction pressing mechanism 514 are driven in synchronization with each other. Therefore, the paired first upper surface pinching roller 51a and first lower surface pinching roller 51b are moved in the rotation axis direction to the workpiece W2 side along the guide rails 5112 and 5142 by the synchronous driving of the actuators 5113 and 5143 in a state of pinching the workpiece W1 from above and below with a predetermined pinching force. As a result, the paired first upper surface pinching roller 51a and first lower surface pinching roller 51b can apply a predetermined pressing force directing to the workpiece W2 to the workpiece W1. At this time, since the second upper surface pinching roller 52a and the second lower surface pinching roller 52b are immovable in the rotation axis direction in a state of pinching the workpiece W2 from above and below with a predetermined pinching force, the joint target portions W1l and W21 of the workpieces W1 and W2 which are caused to butt against each other are pressed in such a direction as to come into close contact with each other.

In the present embodiment, the first upper surface pinching roller 51a, the first lower surface pinching roller 51b and the lower surface width direction pressing mechanism 514 constitute a second pressor that presses at least one (workpiece W1) of the workpieces W1 and W2 toward the other (workpiece W2) at a position where the workpieces W1 and W2 are irradiated with laser light from the laser irradiation unit 2 out of pressors for pressing at least one (workpiece W1) of the workpieces W1 and W2 to the other (workpiece W2) to cause the joint target portions W11 and W21 to butt against each other.

### (Holding Roller)

Holding rollers for pinching the workpieces W1 and W2 from above and below are provided on the upstream side of the first upper surface pinching roller 51a and the first lower surface pinching roller 51b and on the upstream side of the second upper surface pinching roller 52a and the second lower surface pinching roller 52b, respectively. The holding rollers are constituted by a pair of a first upper surface holding roller 61a and a first lower surface holding roller 61b and a pair of a second upper surface holding roller 62a and a second lower surface holding roller 62b. The rotation axes of the first upper surface holding roller 61a and the first lower surface holding roller 61b and the rotation axes of the second upper surface holding roller 62a and the second lower surface holding roller 62b are arranged along the width direction of the joining apparatus 1, respectively.

In the present embodiment, as shown in FIG. 3, the lengths in the rotation axis direction of the first upper surface holding roller 61a and the first lower surface holding roller 61b, and the lengths in the rotation axis direction of the second upper surface holding roller 62a and the second lower surface holding roller 62b are each about half of the lengths in the rotation axis direction of the upper surface pinching roller 51a and the first lower surface pinching roller 51b, and about half of the lengths in the rotation axis direction of the second upper surface pinching roller 52a and the second lower surface pinching roller 52b, respectively. Therefore, the distance between the pair of first upper surface holding roller 61a and the first lower surface holding roller 61b and the butting site Wa, and the distance between the pair of second upper surface holding roller 62a and the second lower surface holding roller 62b and the butting site Wa are larger than the distance between the pair of first upper surface pinching roller 51a and the first lower surface pinching roller 51b and the butting site Wa and the distance between the pair of second upper surface pinching roller 52a and the second lower surface pinching roller 52b and the butting site Wa.

The first upper surface holding roller 61a is rotatably attached to an upstream end of one roller support frame 512a that rotatably supports the first upper surface pinching roller 51a. The first lower surface holding roller 61b is rotatably attached to an upstream end of one roller support frame 512b that rotatably supports the first lower surface pinching roller 51b. The paired first upper surface holding roller 61a and first lower surface holding roller 61b are arranged on the workpiece W1 side with respect to the butting site Wa, and pinch the workpiece W1 from above and below at the same time when the first upper pinching roller 51a and the first lower surface pinching roller Sib pinch the workpiece W1 from above and below by driving the actuator 5152 of the first downward pressing mechanism 515.

The second upper surface holding roller 62a is rotatably attached to an upstream end of one roller support frame 521a that rotatably supports the second upper surface pinching roller 52a. The second lower surface holding roller 62b is rotatably attached to an upstream end of one roller support frame 521b that rotatably supports the second lower surface pinching roller 52b. The paired second upper surface holding roller 62a and second lower surface holding roller 62b are arranged on the workpiece W2 side with respect to the butting site Wa, and pinch the workpiece W2 from above and below at the same time when the second upper surface pinching roller 52a and the second lower surface pinching roller 52b by driving the actuator 5162 of the second downward pressing mechanism 516.

More specifically, as shown in FIGS. 2, 3 and 4, the paired first upper surface holding roller 61a and first lower surface holding roller 61b are arranged between the first upstream side roller 31a and the first downstream side roller 31b along the moving direction of the workpieces W1 and W2 and on the workpiece W1 side in the vicinity of an intersection point 4c between the flat surface portion 4a and the ridgeline 4b of the separating member 4. The paired second upper surface holding roller 62a and second lower surface holding roller 62b are arranged between the second upstream side roller 32a and the second downstream side roller 32b along the moving directions of the workpieces W1 and W2 and on the workpiece W2 side in the vicinity of the intersection point 4c between the flat surface portion 4a and the ridgeline 4b of the separating member 4.

The pair of the first upper surface holding roller 61a and the first lower surface holding roller 61b and the pair of the second upper surface holding roller 62a and the second lower surface holding roller 62b pinch the workpieces W1 and W2 from above and below on both sides of the separating member 4 respectively, whereby the deformation range of the butting site Wa is restrained so that a region turned up by the separating member 4 does not excessively expand to both sides of the butting site Wa. Further, the first upper surface holding roller 61a and the first lower surface holding roller 61b, and the second upper surface holding roller 62a and the second lower surface holding roller 62b also have a function of effectively suppressing the vibration of the joint target portions W11 and W21 caused by the movement of the workpieces W1 and W2 by pinching the workpieces W1 and W2 from above and below on both sides of the separating member 4, respectively.

The first upper surface holding roller 61a and the first lower surface holding roller 61b, and the second upper surface holding roller 62a and the second lower surface holding roller 62b in the present embodiment constitute a restrainer that restrains a deformation range of the butting site Wa when the butting site Wa is turned up by the separating member 4.

### (Workpiece Joining Operation by Joining Apparatus)

Next, a joining operation of the joining apparatus 1 when the joint target portions W11 and W21 of the workpieces W1 and W2 are joined to each other will be described.

First, the workpieces W1 and W2 are aligned with each other so that the respective joint target portions W11 and W21 butt against each other, and introduced onto the guide rollers 17 from the upstream side of the joining apparatus 1. After the workpieces W1 and W2 introduced onto the guide rollers 17 successively pass through between the first upper surface holding roller 61a and the first lower surface holding roller 61b and between the second upper surface holding roller 62a and the second lower surface holding roller 62b and then pass between the first upper surface pinching roller 51a and the first lower surface pinching roller 51b and between the second upper surface pinching roller 52a and the second lower surface pinching roller 52b in a state of being sandwiched between the first upstream side roller 31a and the second upstream side roller 32a and between the first downstream side roller 31b and the second downstream side roller 32b, the workpieces W1 and W2 are pinched from above and below by the conveying rollers 15 and 16. The work pieces W1 and W2 pinched by the conveying rollers 15 and 16 start to move at a predetermined speed along the D direction due to the rotation of the conveying rollers 15 and 16. Until the workpieces W1 and W2 start to move due to the rotation of the conveying rollers 15 and 16, the separating member 4 is evacuated below the moving path of the workpieces W1 and W2 so as not to interfere with the introduction operation of the work pieces W1 and W2.

When the workpieces W1 and W2 start to move, the first upstream side roller 31a and the first downstream side roller 31b press the side end portion W12 of the workpiece W1 with a predetermined pressing force by driving the actuator 3123 of the side pressing mechanism 312, whereby the joint target portions W1l and W21 are brought into close contact with each other. Further, by driving the actuators 5152 and 5162 of the first downward pressing mechanism 515 and the second downward pressing mechanism 51, the first upper surface pinching roller 51a and the second upper surface pinching roller 52a arranged on the upper surface sides of the workpieces W1 and W2 are moved to the workpieces W1 and W2 respectively, and pinch the workpieces W1 and W2 with a predetermined pinching force with the first lower surface pinching roller 51b and the second lower surface pinching roller 52b arranged on the lower surface sides of the workpieces W1 and W2.

Further, when the workpieces W1 and W2 start to move, the separating member 4 moves upward to a position slightly above the upper ends of the guide rollers 17 for supporting the lower surfaces of the workpieces W1 and W2 by driving the elevating actuator 41 to press the butting site Wa of the workpieces W1 and W2 from a lower side to an upper side. As a result, the butting site Wa rides on the upper surface of the separating member 4 from the flat surface portion 4a of the separating member 4, and is guided to the ridgeline 4b at the top. As shown in FIG. 5, the ridgeline 4b of the separating member 4 deforms a part of the butting site Wa so that the part of the butting site Wa is turned up to right and left from the lower side to the upper side, thereby separating the joint target portions W11 and W21 from each other. The end faces W11a and W21a of the separated joint target portions W1l and W21 are exposed slightly upward, respectively.

The separating member 4 is continued to be arranged at a rising position while the workpieces W1 and W2 are moving, whereby the butting site Wa of the workpieces W1 and W2 is deformed to be continuously turned up. However, as shown in FIGS. 3 and 4, the first upper surface pinching roller 51a and the first lower surface pinching roller 51b, and the second upper surface pinching roller 52a and the second lower surface pinching roller 52b are arranged just on the downstream side of the separating member 4 so as to be close to both sides of the butting site Wa, and pinch and press the workpieces W1 and W2 from above and below so that the joint target portions W1l and W21 are in close contact with each other. Therefore, after passing the separating member 4, the joint target portions W11 and W21 that have been turned up and separated from each other by the separating member 4 are immediately pinched by the first upper surface pinching roller 51a and the first lower surface pinching roller 51b, and the second upper surface pinching roller 52a and the second lower surface pinching roller 52b, whereby the joint target portions W11 and W21 are deformed to be flat and approach each other again. Therefore, the separating member 4 only deforms the joint target portions W1l and W21 of the workpieces W1 and W2 so that the joint target portions W11 and W12 are temporarily separated from each other.

Further, since the first upper surface holding roller 61a and the first lower surface holding roller 61b, and the second upper surface holding roller 62a and the second lower surface holding roller 62b are arranged on both sides of the separating member 4, the respective deformations of the joint target portions W11 and W21 are prevented from excessively spreading to both sides of the butting site Wa, so that the deformation range of the butting site Wa is suppressed. Moreover, the vibration of the joint target portions W11 and W21 caused by the movement of the workpieces W1 and W2 is also suppressed.

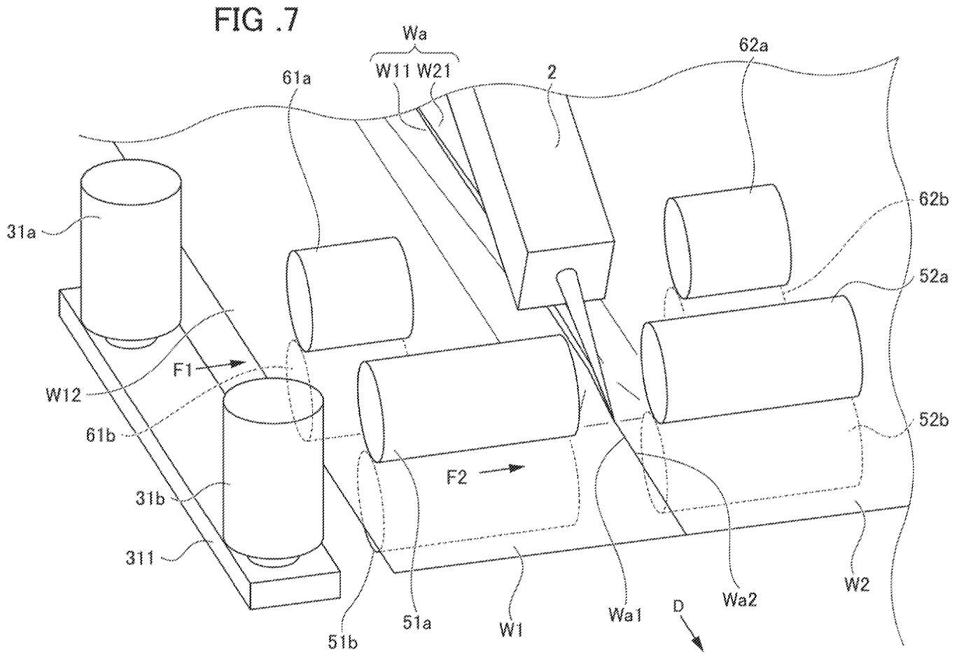

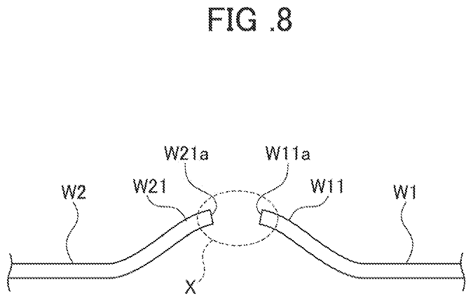

On the downstream side of the separating member 4, the joining apparatus 1 applies laser light from the laser irradiation unit 2 to the butting site Wa between the first upper surface pinching roller 51a and the second upper surface pinching roller 52a after the butting site Wa is separated by the separating member 4. Specifically, as shown in FIG. 7, the laser irradiation unit 2 applies the laser light in the vicinity of a re-approaching site Wa1 at which the joint target portions W11 and W21 of the workpieces W1 and W2 separated by the separating member 4 approach each other again, concretely, toward the just upstream side of the re-approaching site Wa1. Since the joint target portions W11 and W21 are still separated from each other on the just upstream side of the re-approaching site Wa1, a region X containing end faces W11a and W21a of the separated joint target portions W11 and W21 is irradiated with laser light as shown in FIG. 8. Therefore, since the end faces W11a and W21a of the joint target portions W11 and W21 are also irradiated with the laser light, the joint target portions W11 and W21 of the workpieces W1 and W2 are efficiently heated with a small amount of heat, and galvanized (zinc-plated) layers formed on the end faces W11a and W21a are also sufficiently removed by the laser light.

As shown in FIG. 7, the joint target portions W1l and W21 which have been melted by the laser light are caused to butt against each other again at the re-approaching site Wa1 to form a joint site Wa2. The galvanized layers on the end faces W11a and W21a of the joint target portions W11 and W21 are sufficiently removed at the re-approaching site Wa1, so that the joint target portions W11 and W21 can be joined in excellently close contact with each other at the joint site Wa2. Therefore, with this joining apparatus 1, excessive heating can be suppressed, and the joint quality of the workpieces W1 and W2 can be enhanced. Further, since it is possible to efficiently heat the joint target portions W11 and W21 of the workpieces W1 and W2, it is expected to improve the processing speed and reduce the capital investment of the laser oscillator.

With the joining apparatus 1 of the present embodiment, the excessive deformation and vibration of the joint target portions W1l and W21 of the workpieces W1 and W2 are suppressed by the first upper surface holding roller 61a and the first lower surface holding roller 61b, and the second upper surface holding roller 62a and the second lower surface holding roller 62b, which makes it easy to position the workpieces W1 and W2 when the separated joint target portions W11 and W21 approach each other again at the re-approaching site Wa1. As a result, the joint quality of the workpieces W1 and W2 is further enhanced.

As shown in FIGS. 3 and 7, when a pressing force with which the paired first upstream side roller 31a and first downstream side roller 31b press the workpiece W1 to the workpiece W2 for joining the workpieces W1 and W2 is represented by F1, and a pressing force with which the paired first upper surface pinching roller 51a and first lower surface pinching roller 51b press the workpiece W1 to the workpiece W2 for joining the workpieces W1 and W2 is represented by F2, it is preferable that F1<F2 is satisfied. The pressing force to be applied to the workpieces W1 and W2 to cause the joint target portions W11 and W21 to butt against each other is set to be larger after or around irradiation of laser light than that before irradiation of laser beam, whereby the joint target portions W11 and W21 which have been melted by the laser light can be brought into excellent contact with each other. Therefore, the joint quality of the workpieces W1 and W2 can be further enhanced.

In the above-described embodiment, the workpiece W1 is pressed to the workpiece W2 by moving the pair of the first upstream side roller 31a and the first downstream side roller 31b in the width direction of the joining apparatus 1. However, the workpiece W2 may be pressed to the workpiece W1 by providing the paired second upstream side roller 32a and second downstream side roller 32b so as to be movable in the width direction of the joining apparatus 1. Further, both the workpieces W1 and W2 may be pressed against each other so as to come into close contact with each other by providing the first upstream side roller 31a and the first downstream side roller 31b and the second upstream side roller 32a and the second downstream side roller 32b so as to be movable in the width direction of the joining apparatus 1.

In the above-described embodiment, the workpiece W1 may be pressed to the workpiece W2 by moving the paired first upper surface pinching roller 51a and first lower surface pinching roller 51b in the width direction of the joining apparatus 1. However, the workpiece W2 may be pressed to the workpiece W1 by providing the second upper surface pinching roller 52a and the second lower surface pinching roller 52b so as to be movable in the width direction of the joining apparatus 1. Further, both the workpieces W1 and W2 may be pressed against each other so as to come into close contact with each other by providing the first upper surface pinching roller 51a and the first lower surface pinching roller 51b and the second upper surface pinching roller 52a and the second lower surface pinching roller 52b so as to be movable in the width direction of the joining apparatus 1.

### EXPLANATION OF REFERENCE NUMERALS

1 joining apparatus
15, 16 conveying roller (workpiece moving mechanism)
17 guide rollers (workpiece moving mechanism)
2 laser irradiation unit (laser irradiator)
4 separating member (separator)
31a first upstream side roller (pressor, first pressor)
31b first downstream side roller (pressor, first pressor)
312 side pressing mechanism (pressor, first pressor)
51a first upper surface pinching roller (pressor, second
pressor)
51b first lower surface pinching roller (pressor, second
pressor)
511 upper surface width direction pressing mechanism (pressor,
second pressor)
514 lower surface width direction pressing mechanism (pressor,
second pressor)
61a first upper surface holding roller (restrainer)
61b first lower surface holding roller (restrainer)
62a second upper surface holding roller (restrainer)
62b second lower surface holding roller (restrainer)
W1 workpiece (first workpiece)
W2 workpiece (second workpiece)
W11 joint target portion (first joint target portion)
W21 joint target portion (second joint target position)
Wa butting site
Wa1 re-approaching site
F1 pressing force of first pressor
F2 pressing force of second pressor

What is claimed is:

1. A joining apparatus for joining a first workpiece having a first joint target portion extending linearly and a second workpiece having a second joint target portion extending linearly, comprising:
a pressor that presses at least one of the first workpiece and the second workpiece to the other workpiece to cause the first joint target portion and the second joint target portion to butt against each other;
a workpiece moving organizer that moves the first workpiece and the second workpiece along an extending direction of the first joint target portion and the second target portion in a state where the first joint target portion and the second joint target portion are caused to butt against each other;
a separator that temporarily separates the first joint target portion and the second joint target portion from each other by deforming a part of a butting site between the first joint target portion and the second joint target portion so that the part of the butting site is turned up during a moving process of the first workpiece and the second workpiece; and
a laser irradiator that irradiates a site at which the first joint target portion and the second joint target portion separated from each other approach each other again, with laser light on a downstream side of the separator in a moving direction of the first workpiece and the second workpiece.

2. The joining apparatus according to claim 1, wherein the pressor comprises a first pressor that presses at least one of the first workpiece and the second workpiece to the other before the laser light is radiated by the laser irradiator, and a second pressor that presses at least one of the first workpiece and the second workpiece to the other at a position where the site is irradiated with the laser light by the laser irradiator, and
the second pressor has a larger pressing force than that of the first pressor.

3. The joining apparatus according to claim 1, wherein the pressor includes a restrainer that restrains a deformation range of the butting site when the butting site is turned up by the separator.
